(19) United States
(12) Patent Application Publication
(10) Pub. No.: US 2020/0282796 A1
(43) Pub. Date: Sep. 10, 2020

(54) DEVICE FOR OPERATING A MOTOR VEHICLE AIR CONDITIONING SYSTEM AND INTERIOR TEMPERATURE SENSOR UNIT FOR SUCH AN AIR CONDITIONING SYSTEM

(71) Applicant: BEHR-HELLA THERMOCONTROL GMBH, Stuttgart (DE)

(72) Inventors: Ralph TRAPP, Paderborn (DE); Dirk NAGEL, Paderborn (DE); Rudiger SCHMIDT, Paderborn (DE); Bernd KUHLHOFF, Lippstadt (DE); Eduard PANKRATZ, Lippetal (DE)

(21) Appl. No.: 16/645,189

(22) PCT Filed: Sep. 12, 2018
(86) PCT No.: PCT/EP2018/074574

§ 371 Date: Mar. 6, 2020

(30) Foreign Application Priority Data
Sep. 27, 2017 (DE) 10 2017 122 469.6

(51) Int. Cl. B60H 1/00; G01K 13/02; B60K 37/06

(52) U.S. Cl. CPC B60H 1/0073; B60H 1/00792; G01K 13/02; B60K 2370/12; B60K 37/06; G01K 2013/024; G01K 2201/02; B60H 1/0075

(57) ABSTRACT

The invention relates to a device for operating an air conditioning system (12) of a vehicle. The air conditioning system has a fan, a plurality of actuating motors for controlling flaps on and/or in air-conducting channels, a heating and/or a cooling unit, and a plurality of sensors (28, 30) for sensing measurement variables required for the operation of the heating, ventilation and/or air conditioning system. The sensors (28, 30) include an interior temperature sensor (26). The device has an operating and control unit (32) for inputting a desired temperature and for outputting air conditioning control signals for the control of components of the air conditioning system. The device also has a processing unit (40), which is arranged outside of and/or separate from the operating and control unit (32) and to which measurement signals from the interior temperature sensor (26) and from at least some of the other sensors (28, 30) of the air conditioning system can be supplied and which processes said measurement signals further to form air conditioning control signals.

The invention relates to a device for operating a vehicle heating, ventilation and/or air conditioning system, as well as to an interior temperature sensor unit for such heating, ventilation and/or air conditioning system.

Typically, a vehicle heating, ventilation and/or air conditioning system is controlled in and by a control unit installed in the vehicle, in particular an air conditioning control unit, which is a unit separate from other control units. For the control, various sensor variables are typically required, such as e.g. relative to the interior temperature, as well as to the current operational states of various components of the air conditioning system and to the vehicle environment (e.g. outside temperature, solar irradiation etc.).

Examples for devices for controlling an air conditioning system and/or a plurality of vehicle components are known from DE-A-199 41 951, DE-B-10 2008 064 011 and EP-A-1 080 956.

With vehicles, a trend has prevailed in recent years to operate a plurality of different vehicle components through a common control unit, this common control unit also performing the calculation of the sensor variables required for the various vehicle components. The concentration of the software for controlling the various vehicle components is advantageous with regard to production costs in that the computing power required for controlling the vehicle components can be concentrated in a single or a few processors.

During the development phase, however, uniting a plurality of software functions for a plurality of vehicle components in a single control unit causes problems in that software updates have to be coordinated among a plurality of vehicle parts suppliers that supply the individual components to be controlled by the central control unit. This coordination may cause delays in the development of the software for e.g. the air condition control of a vehicle.

It is an object of the invention to provide a conception for a device for operating a vehicle heating, ventilation and/or air conditioning system, in which, despite the integration of the operation of the heating, ventilation and/or air conditioning system with the operation of other components in a central control unit, the degree of freedom in designing the software is nonetheless increased.

To achieve this object the invention provides a device for controlling and operating a vehicle heating, ventilation and/or air conditioning system and further vehicle components, the heating, ventilation and/or air conditioning system being provided inter alia with
a blower,
a plurality of actuating motors for controlling flaps at and/or in channels directing air into the vehicle,
a heating and/or cooling aggregate,
a plurality of first sensors for sensing measuring variables necessary for the operation of the heating, ventilation and/or air conditioning system and
at least one second sensor as an interior temperature sensor for sensing an actual value representing the interior room temperature of the vehicle,
wherein the device is provided with
   an operating and control unit for
      the input of inter alia a set temperature for the interior of the vehicle,
      the input of parameters and operating commands for the operation of the heating, ventilation and/or air conditioning system and the further vehicle components,
      the output of air condition control signals for controlling the blower, the actuating motors and the heating and/or the cooling aggregate of the heating, ventilation and/or air conditioning system, and
      the determination and the output of component control signals for the control of the further vehicle components,
a processing unit arranged outside of and/or separate from the operating and control unit and connected with the operating and control unit, to which processing unit measuring signals can be supplied from the at least one interior temperature sensor, as well as from at least some of the first sensors of the heating, ventilation and/or air conditioning system, the processing unit further processing these measuring signals into air conditioning control signals which can be supplied to the operating and control unit for controlling the blower, the actuating motors and/or the heating and/or the cooling aggregate or for further processing for controlling the blower, the actuating motors and/or the heating and/or the cooling aggregate of the heating, ventilation and/or air conditioning system.

Further, the above object is achieved according to the invention with an interior temperature sensor unit for a vehicle heating, ventilation and/or air conditioning system comprising an actuator system, wherein the interior temperature sensor unit is provided with
at least one and preferably a plurality of interior temperature sensors for determining a variable representing the interior temperature of the vehicle and
a processing unit to which measuring signals can be supplied from the interior temperature sensor or sensors, as well as data representing measuring signals from other sensors of the heating, ventilation and/or air conditioning system, and which processing unit provides signals for the actuator system of the heating, ventilation and/or air conditioning system for transmission to an external control unit for controlling this actuator system of the heating, ventilation and/or air conditioning system.

Basically, the invention consists in the splitting of the functions of the heating, ventilation and/or air conditioning regulation or control between an operating and control unit for a plurality of vehicle components, inter alia also for the heating, ventilation and/or air conditioning system, and a processing unit arranged externally thereof. This processing unit is advantageously associated to the interior temperature sensor and is in particular comprised in one structural unit with the same. The processing unit receives signals from other sensors of the heating, ventilation and/or air conditioning system, whose measuring variables are necessary for regulation/control.

Thus, according to the invention, at least a part of the air condition regulation functions is transferred from the central operating and control unit associated to a plurality of vehicle components to the interior temperature sensor, i.e. a processing unit associated to the same. Together, these functions form in particular the core functions of air conditioning such as the evaluation of (in particular the entire) sensor system and the calculation of the necessary quantity of air, air temperature, as well as the heating or cooling requirement necessary therefor.

The essential part of the core functions of air conditioning also includes, inter alia, the calculation of the actuation variable for the actuator system of the heating, ventilation and/or air conditioning system, such as e.g. the actuation variables for the actuating motors of the flaps at and/or in channels directing air into the vehicle, for the blower and for the heating and/or the cooling aggregate. These are eventually calculated from the requirements made with respect to air quantities, air temperatures, air distribution, heating powers and cooling powers. Thereby, not only the interior temperature is processed in the decentralized processing unit, but also a considerable number of further air condition regulation functions is performed. In order to calculate these functions, the required information is made available to the processing unit e.g. via a bus communication. The calculation results are transmitted via the bus communication to further control units and in particular to the operating and control unit which can use these to operate the various actuator systems of the heating, ventilation and/or air conditioning system.

The advantage of splitting the air conditioning functions, as provided by the invention, between the control of the air conditioning system by the central operating and control unit and the calculation of the actuation variables for the control of the air conditioning system by a processing unit which is decentralized with respect to the operating and control unit, consists in the flexibility in the software development for the heating, ventilation and/or air conditioning system. Prior thereto, the interfaces between the processing unit or the interior temperature sensor on the one hand and the central operating and control unit have to be defined. Here, the connection is feasibly made via a standard bus communication, e.g. CAN. Software changes for determining the signals and data for controlling the air conditioning system, which are to be transmitted via this bus communication interface, now require no change in the software for operating the central operating and control unit, which means additional flexibility as far as the software designer is concerned.

In an advantageous embodiment of the invention it may be provided that the first sensors are connected to the operating and control unit and supply their measuring signals to the same, wherein the operating and control unit supplies data representing these measuring signals to the processing unit. In this variant of the invention the various sensors for the operation of the are conditioning system are connected to the central operating and control unit. This does not apply to the at least one interior temperature sensor. The further sensors (first sensors) are of various types and hardware and in part provide analog measuring signals, but in part also provide digitalized measuring signals. They may be used for different functions. For example the outside temperature sensor, which is typically required for the operation of an air conditioning system, may also be used to indicate to a driver in winter that temperature has fallen below a minimum. But also in very general terms it is common today that the outside temperature is displayed on the dashboard of a vehicle. The measuring signals of these first sensors are advantageously converted in the operating and control unit to be subsequently transmitted to the external processing unit via e.g. a bus (CAN or LIN bus). Together with the measuring signal from the at least one interior temperature sensor, the actuation variables required for the operation of the air conditioning system are then determined in the processing unit, and these data are transmitted from the processing unit via the bus communication link to the operating and control unit from where they are supplied to the individual components of the air conditioning system to control the same accordingly.

Regarding the type of the interior temperature sensor, the same may be vented or not vented. Besides a temperature-sensitive element, a vented internal temperature sensor further requires a ventilation motor. Recently, so-called non-vented interior temperature sensors are increasingly used which comprise a plurality of elements that differ in sensitivity and are sensitive to different ambient parameters. Such non-vented temperature sensors typically comprise two temperature-sensitive measuring elements, as well as a radiation-sensitive element that senses the heating of the non-vented interior temperature sensor caused by heat or solar radiation. The measuring signals of these three elements in common calculated to generate a signal representing the temperature in the interior of the vehicle, which signal is supplied as the actual value of the interior temperature to the regulator (controller) of the air conditioning system.

In a further suitable embodiment of the invention the first sensors may comprise: at least one sensor for sensing the temperature of the air flowing from at least one of the channels and/or at least one sun sensor for sensing the solar irradiation the vehicle interior is exposed to and/or at least one humidity sensor for sensing the relative air humidity of the air reaching in particular a window, in particular the windshield of the vehicle, and/or at least one outside temperature for sensing the temperature of a heating aggregate of the air conditioning system and/or a sensor for sensing the temperature of a cooling aggregate of the air conditioning system.

The invention will be explained hereunder in more detail with reference to an embodiment and with reference to the drawings. In the Figures:

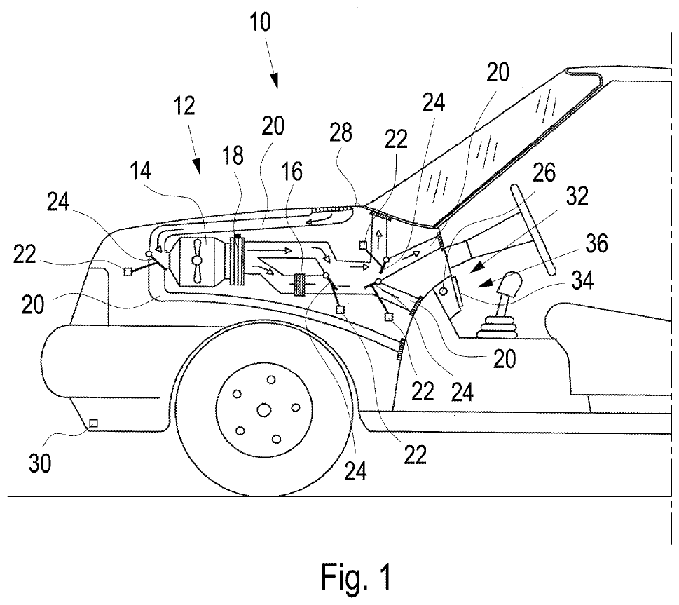

FIG. 1 schematically illustrates a part of a vehicle with some components of an air conditioning system, and

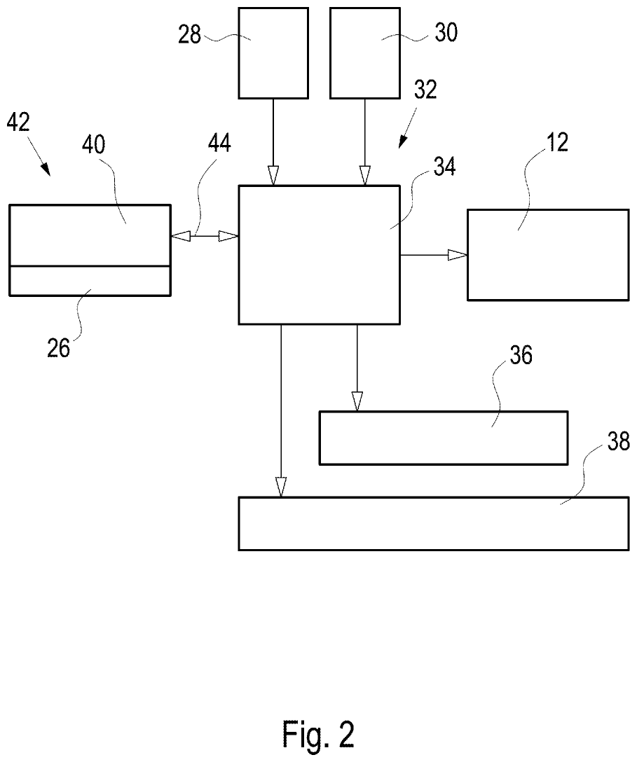

FIG. 2 schematically shows the splitting of the air conditioning functions between a central operating and control unit and a decentral processing unit.

FIG. 1 is a side view and schematic illustration of the front part of a vehicle 10 comprising an air conditioning system 12. The air conditioning system 12 comprises, inter alia, a blower 14, a heating aggregate 16, a cooling aggregate 18, a plurality of air supply channels 20 with actuating motors 26 for flaps 24, and a sensor system comprising e.g. an interior temperature sensor 26, a sun sensor 28 and an outside temperature sensor 30. The interior temperature sensor 26 may comprise one or a plurality of temperature sensors which in their entirety serve to determine an actual variable representing the temperature in the interior.

A central operating and control unit 32 is installed in the dashboard or in the centre console of the vehicle 10, the unit comprising e.g. a touchscreen 34. The operating and control unit 32 serves to control the actuator system of the air conditioning system 12 and e.g. a navigation system 36, and further serves to adjust and/or temperature-control (heat or vent) the seats (see 38 in FIG. 2). Further components such as e.g. an infotainment system or a sunroof device or an automatic roof opening and closing system (in case of a convertible) may also be controlled via the central operating and control unit 32.

According to the invention a part of the air condition control functions has been transferred from the operating and control unit 32 to external means. In the present exemplary case a decentral processing unit 40, which is integrated with e.g. the interior temperature sensor 26, is located in a separate structural unit 42 which communicates with the central operating and control unit 32 via a bus communication 44. Here, the measuring data of other air condition sensors, such as e.g. the sun sensor 28 or the outside temperature sensor 30 or the motor water temperature sensor, the air ejection sensor, the humidity sensor, the heating aggregate sensor, i.e. the heat exchanger temperature sensor, the cooling aggregate sensor, i.e. the evaporator temperature sensor (not illustrated in detail, but indicated by the dots between 28 and 30 in FIG. 2), can be supplied to the processing unit 40 preferably also via bus communication. The above sensors and possibly other sensors (except for the interior temperature sensor 20) supply their measuring signals or measuring data to the central operating and control unit 32 in which these signals are converted for transmission to the processing unit 40 via the bus communication line 44. Together with the measuring signal of the interior temperature sensor 26, the processing unit 40 then calculates the actuation variables for the individual components of the air conditioning system 12, such as e.g. the blower 14, the heating aggregate 15, the cooling aggregate 18 and the various air distribution flaps 24 and also a central mixing flap. These actuation variables are transmitted back to the central operating and control unit 32 via the bus communication line 44, from where they are transmitted to the corresponding components of the air conditioning system 12.

### LIST OF REFERENCE NUMERALS

10 vehicle
12 air conditioning system
14 blower
16 heating aggregate
18 cooling aggregate
20 air supply channels
22 actuating motors
24 flaps
26 interior temperature sensor
28 sun sensor
30 outside temperature sensor
32 control unit
34 screen
36 navigation system
40 processing unit
42 structural unit
44 bus communication

1-6. (canceled)

7. A device for controlling and operating a vehicle heating, ventilation and/or air conditioning system and further vehicle components, the heating, ventilation and/or air conditioning system being provided inter alia with
a blower,
a plurality of actuating motors for controlling flaps at and/or in channels directing air into the vehicle,
a heating and/or cooling aggregate,
a plurality of first sensors for sensing measuring variables necessary for the operation of the heating, ventilation and/or air conditioning system and
at least one second sensor as an interior temperature sensor for sensing an actual value representing the interior room temperature of the vehicle,
wherein the device is provided with
an operating and control unit for
the input of inter alia a set temperature for the interior of the vehicle,
the input of parameters and operating commands for the operation of the heating, ventilation and/or air conditioning system and the further vehicle components,
the output of air condition control signals for controlling the blower, the actuating motors and the heating and/or the cooling aggregate of the heating, ventilation and/or air conditioning system, and
the determination and the output of component control signals for the control of the further vehicle components,
a processing unit arranged outside of and/or separate from the operating and control unit and connected with the operating and control unit, to which processing unit measuring signals can be supplied from the at least one interior temperature sensor, as well as from at least some of the first sensors of the heating, ventilation and/or air conditioning system, the processing unit further processing these measuring signals into air conditioning control signals which can be supplied to the operating and control unit for controlling the blower, the actuating motors and/or the heating and/or the cooling aggregate or for further processing for controlling the blower, the actuating motors and/or the heating and/or the cooling aggregate of the heating, ventilation and/or air conditioning system.

8. The device of claim 7, wherein the first sensors are connected to the operating and control unit and supply their measuring signals to the same, the operating and control unit supplying data representing these measuring signals to the processing unit.

9. The device of claim 7, wherein the at least one interior temperature sensor is vented or that the at least one interior temperature sensor is not vented and comprises two temperature-sensitive measuring elements, as well as a radiation-sensitive element sensing solar irradiation.

10. The device of claim 7, wherein the first sensors comprise at least one sensor for sensing the temperature of the air flowing from at least one of the channels and/or at least one sun sensor for sensing the solar irradiation the vehicle interior is exposed to and/or at least one humidity sensor for sensing the relative air humidity of the air reaching in particular a window, in particular the windshield of the vehicle, and/or at least one outside temperature for sensing the temperature of a heating aggregate of the air conditioning system and/or a sensor for sensing the temperature of a cooling aggregate of the air conditioning system.

11. An interior temperature sensor unit for a vehicle heating, ventilation and/or air conditioning system comprising an actuator system, comprising
at least one and preferably a plurality of interior temperature sensors for determining a variable representing the interior temperature of the vehicle and
a processing unit to which measuring signals can be supplied from the interior temperature sensor or sensors, as well as data representing measuring signals from other sensors of the heating, ventilation and/or air conditioning system, and which processing unit provides signals for the actuator system of the heating, ventilation and/or air conditioning system for transmission to an external control unit for controlling this actuator system of the heating, ventilation and/or air conditioning system.

12. The interior temperature sensor unit of claim 11, wherein the at least one interior temperature sensor is vented or wherein the at least one interior temperature sensor is not vented and comprises two temperature-sensitive measuring elements, as well as a radiation-sensitive element sensing solar irradiation.
